(19) United States
(12) Patent Application Publication
(10) Pub. No.: US 2013/0339258 A1
(43) Pub. Date: Dec. 19, 2013

(54) LEGAL NOTICE CREATION

(71) Applicants: Roman Kisin, San Jose, CA (US); Pierre Raynaud-Richard, Redwood City, CA (US); Irina Simpson, Sunnyvale, CA (US)

(72) Inventors: Roman Kisin, San Jose, CA (US); Pierre Raynaud-Richard, Redwood City, CA (US); Irina Simpson, Sunnyvale, CA (US)

(73) Assignee: INTERNATIONAL BUSINESS MACHINES CORPORATION, Armonk, NY (US)

(21) Appl. No.: 13/523,079

(22) Filed: Jun. 14, 2012

(51) Int. Cl. G06Q 50/18

(52) U.S. Cl. 705/311

(57) ABSTRACT

A method, system, and computer program product for creating legal notices and workflows based on predefined templates. A plurality of content templates for a legal notice is provided, the content templates comprising at least one attribute related to the legal matter. A plurality of processing rule templates for a legal notice is provided, the processing rule templates comprising at least one processing rule defining rules and workflows surrounding the legal notice. Responsive to receiving selection of a content template and a processing rule template, a legal notice and workflows are generated based on the selected content template and the selected processing rule template.

### BACKGROUND

Embodiments described herein relate to use of computer software which generates legal notices and workflows based on predefined templates.

Corporate legal departments typically face a substantial volume of litigation. Discovery refers to a pre-trial phase of the litigation process where parties exchange information related to the civil action. In recent years, the proliferation of technology has allowed for the exchange of information, such as documents, electronically. The term “eDiscovery” has been adopted to refer to the electronic discovery process. The discovery process, electronic or otherwise, requires attorneys, paralegals, and support staff in legal departments to track and respond to a significant number of different matters. The discovery process was traditionally managed by individuals who maintained and updated spreadsheets and emails to track key items and events in the discovery process. This management system resulted in high overhead, poor quality, significant mistakes, and untenable risk. The adoption of eDiscovery has made these methods of management unsustainable, resulting in a number of software applications designed to automate the discovery process.

Discovery is a critical component of most civil actions. As part of the discovery process, parties to the action serve upon the opposition a discovery request, which identifies a number of items sought to be discovered. Current discovery rules permit discovery through a number of methods, including, but not limited to, requests for answers to interrogatories, requests for production of documents, requests for admissions, and depositions. For example, an employee-plaintiff in a wrongful termination lawsuit may serve a request for production of documents on an employer-defendant, seeking all documents related to the firing of the employee, which forms the basis of the employee's cause of action against the employer. Upon receiving the request, the legal department of the corporation is under an obligation to identify and preserve any documents, such as emails, related to the firing of the employee, such that they may be duplicated and returned to the employee-plaintiff. When the items requested are in digital format, eDiscovery rules apply, such that the employer-defendant must preserve the documents and provide them in a digital format. In some instances, a non-party may be served a discovery request if it possesses information relevant to the lawsuit. The number of documents subject to the discovery request may count in the hundreds, thousands, millions, or more, and may be possessed by numerous individuals in multiple different formats across any number of computers in any number of different jurisdictions.

In response to the discovery request, members of the legal department must place all documents subject to the discovery request, identified or unidentified, under a legal hold. The first step in the legal hold process is the transmission of a hold notice to all custodians who may possess the documents. The hold notice will typically indicate the relevant documents subject to the hold, and direct the custodians to preserve any document which may be relevant to the action to prevent spoliation. Spoliation is the intentional or negligent withholding, hiding, altering, or destroying of evidence relevant to a legal proceeding. If, for example, the corporation has a policy under which documents (electronic or paper) are destroyed on a periodic interval, the hold notice will direct the custodians to suspend the policy as to the documents subject to the legal hold. Although hold notices may be sent in response to discovery requests, corporations are under a preservation obligation in numerous settings. The preservation obligation generally extends to all forms of relevant information when litigation (including government audits, regulatory proceedings, etc.) is reasonably anticipated. Litigation, or any of its analogs, need not be current or pending in order to trigger the duty to preserve relevant evidence. A hold notice would be necessary in any of these situations to prevent the spoliation of evidence.

A hold notice typically must be drafted by an attorney for the corporation who incorporates all relevant information into the notice. The notice must be individually tailored for each specific legal matter, resulting in a time consuming process for legal department staff. A hold notice may take any number of forms depending on the phase of the preservation. Some examples include, but are not limited to, an initial hold notice, a change notice, and reminder notices. An initial hold notice is generated when a notice is initially published by the legal department of the corporation, and informs the custodians of the preservation obligation. A change notice is generated in order to notify recipients of initial hold notices or previous change notices that terms of the legal hold have changed. For example, the legal hold may be expanded or contracted to cover a larger or smaller number of documents as the litigation process evolves. Reminder notices are communicated on a periodic to remind custodians of their legal obligations.

A legal notice, such as a hold notice, change notice, or reminder notice, is accompanied by a number of policies related to the lifecycle of the legal notice. For example, a legal department may monitor receipt, acceptance, and compliance with the notice, and provide a number of escalation methods for addressing noncompliance with the terms of the notice. To monitor the lifecycle of legal notices, legal departments define a number of workflows to handle all aspects of the legal notice, which include, but are not limited to, policies related to the creation, transmission, and monitoring of the legal notice.

Companies typically have a handful of attorneys creating legal notice templates and reviewing workflow processes designed to enforce some level of consistency and compliance with the legal notice. Companies today would benefit greatly from a repeatable, defensible, and standardized process around the creation and management of legal notices to maximize efficiency, reliability, and effectiveness. Due to the increased amount of litigation and complexity of legal holds, the creation of flexible notices would be beneficial. For example, hold notices can be configured to provide tiered escalation workflows, responsive to noncompliance or unresponsiveness to the legal notice, which can be configured differently for people in different positions, organizations, jurisdictions, etc.

In addition, due to the increased complexity of an eDiscovery notice lifecycle and the dynamic nature of a notice's contents, a simple process to review notices and providing basic content templates for generation of legal notices becomes inadequate in terms of being repeatable, defensible, and scalable, and fails to produce quality notices with any level of consistency.

### SUMMARY

Embodiments described herein provide a method, system, and computer program product for creating legal notices in a matter in an electronic discovery management system by, providing a plurality of content templates for a legal notice, the content templates each comprising at least one attribute of the legal notice, wherein each content template is specific to a type of matter in the electronic discovery management system, providing a plurality of processing rule templates, each processing rule template comprising at least one processing rule, wherein the at least one processing rule defines rules and workflows related to at least one of the: (i) creation, (ii) transmission, and (iii) monitoring of the legal notice; wherein combinations of the processing rule templates and the content templates is used to generate legal notices and, responsive to receiving selection of a first content template and a first processing rule template, generating, by operation of one or more computer processors, a legal notice and workflows based on the first content template and the first processing rule template.

### BRIEF DESCRIPTION OF THE DRAWINGS

So that the manner in which the above recited aspects are attained and can be understood in detail, a more particular description of embodiments of the invention, briefly summarized above, may be had by reference to the appended drawings.

It is to be noted, however, that the appended drawings illustrate only typical embodiments of this invention and are therefore not to be considered limiting of its scope, for the invention may admit to other equally effective embodiments.

FIG. 1 is a block diagram of a system for generating legal notices and workflows based on predefined templates, according to one embodiment described herein.

FIG. 2 illustrates an exemplary content template, according to one embodiment described herein.

FIG. 3 illustrates an exemplary processing rule template, according to one embodiment described herein.

FIG. 4 is a is a flowchart illustrating a method for generating legal notices and workflows based on predefined templates, according to one embodiment described herein.

FIG. 5 is a flowchart illustrating a method for generating legal notices and workflows, according to one embodiment described herein.

FIG. 6 is a flowchart illustrating a method for resolving a set of processing rules, according to one embodiment described herein.

### DETAILED DESCRIPTION

Embodiments described herein provide a method, system, and computer program product for creating legal notices and workflows based on predefined templates. A plurality of content templates for a legal notice is provided, the content templates comprising at least one attribute related to the legal matter. A plurality of processing rule templates for a legal notice is provided, the processing rule templates comprising at least one processing rule defining rules and workflows surrounding the legal notice. Responsive to receiving selection of a content template and a processing rule template, a legal notice and workflows are generated based on the selected content template and the selected processing rule template.

In the following, reference is made to embodiments of the disclosure. However, it should be understood that the disclosure is not limited to specific described embodiments. Instead, any combination of the following features and elements, whether related to different embodiments or not, is contemplated to implement and practice the disclosure. Furthermore, although embodiments may achieve advantages over other possible solutions and/or over the prior art, whether or not a particular advantage is achieved by a given embodiment is not limiting of the disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of embodiments disclosed herein may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments disclosed herein. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Embodiments described herein may be provided to end users through a cloud computing infrastructure. Cloud computing generally refers to the provision of scalable computing resources as a service over a network. More formally, cloud computing may be defined as a computing capability that provides an abstraction between the computing resource and its underlying technical architecture (e.g., servers, storage, networks), enabling convenient, on-demand network access to a shared pool of configurable computing resources that can be rapidly provisioned and released with minimal management effort or service provider interaction. Thus, cloud computing allows a user to access virtual computing resources (e.g., storage, data, applications, and even complete virtualized computing systems) in “the cloud,” without regard for the underlying physical systems (or locations of those systems) used to provide the computing resources.

Typically, cloud computing resources are provided to a user on a pay-per-use basis, where users are charged only for the computing resources actually used (e.g. an amount of storage space consumed by a user or a number of virtualized systems instantiated by the user). A user can access any of the resources that reside in the cloud at any time, and from anywhere across the Internet. In context of the present disclosure, a user may access applications for generating legal notices or related data available in the cloud. For example, the application could execute on a computing system in the cloud and create legal notices. In such a case, the application could generate legal notices based on predefined templates and store the legal notices at a storage location in the cloud. Doing so allows a user to access this information from any computing system attached to a network connected to the cloud (e.g., the Internet).

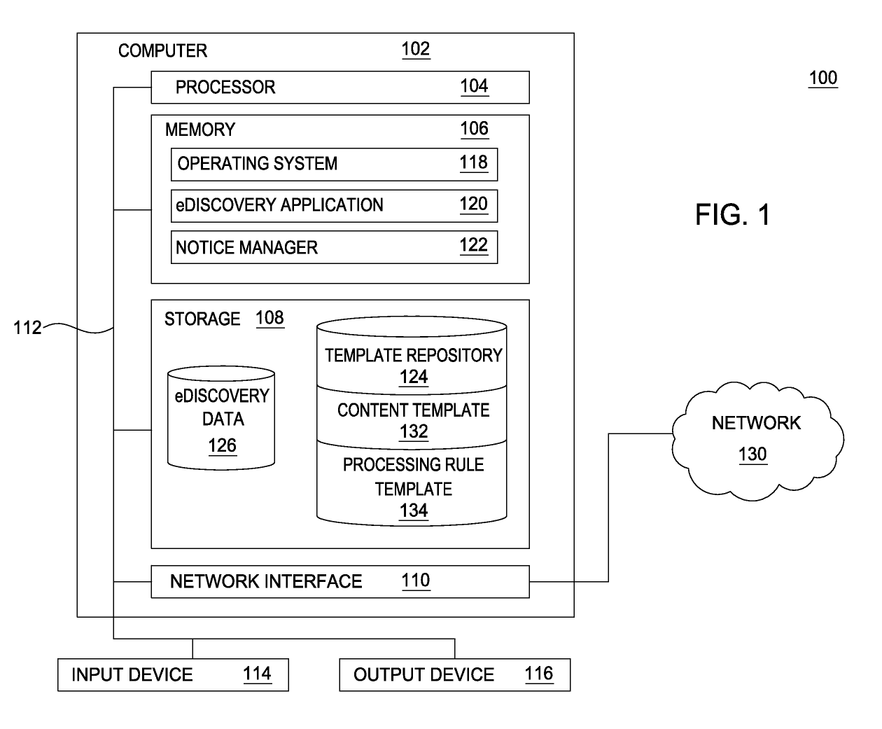

FIG. 1 is a block diagram illustrating a system 100 for generating legal notices and workflows based on predefined templates, according to one embodiment described herein. The system 100 includes a computer 102. The computer 102 may be connected to other computers via a network 130. In general, the network 130 may be a telecommunications network and/or a wide area network (WAN). In a particular embodiment, the network 130 is the Internet.

The computer 102 generally includes a processor 104 connected via a bus 112 to a memory 106, a network interface device 110, a storage 108, an input device 114, and an output device 116. The computer 102 is generally under the control of any commercially available or open source operating system 118 supporting the functions disclosed herein. The processor 104 is included to be representative of a single CPU, multiple CPUs, a single CPU having multiple processing cores, and the like. Similarly, the memory 106 may be a random access memory. While the memory 106 is shown as a single entity, it should be understood that the memory 106 may comprise a plurality of modules, and that the memory 106 may exist at multiple levels, from high speed registers and caches to lower speed but larger DRAM chips. The network interface device 110 may be any type of network communications device allowing the computer 102 to communicate with other computers via the network 130.

The storage 108 may be a hard disk drive storage device. Although the storage 108 is shown as a single unit, the storage 108 may be a combination of fixed and/or removable storage devices, such as fixed disc drives, removable memory cards, optical storage, flash memory or solid state storage devices (SSD). The memory 106 and the storage 108 may be part of one virtual address space spanning multiple primary and secondary storage devices.

The input device 114 may be any device for providing input to the computer 102. For example, a keyboard, keypad, light pen, touch-screen, track-ball, or speech recognition unit, audio/video player, and the like may be used. The output device 116 may be any device for providing output to a user of the computer 102. For example, the output device 116 may be any conventional display screen or set of speakers, along with their respective interface cards, i.e., video cards and sound cards. Although shown separately from the input device 114, the output device 116 and input device 114 may be combined. For example, a display screen with an integrated touch-screen, a display with an integrated keyboard, or a speech recognition unit combined with a text speech converter may be used.

As shown, the memory 106 contains eDiscovery application 120. The eDiscovery application 120 is a general purpose eDiscovery management application used to manage all aspects of the eDiscovery process. In some embodiments, eDiscovery application 120 provides a method to store and track information related to legal matters within an organization. In some embodiments, eDiscovery application 120 defines workflows for each of the processes within a legal matter, provides mechanisms to issue notices and alerts related to steps in the workflow, and methods to track progress of items within the workflow. In some embodiments, eDiscovery application 120 automates communication of discovery requirements and facts between legal staff and custodians with automatic action item assignments, notifications, alerts, work planning and views of holds and collections. One example of an eDiscovery management application is IBM® Atlas eDiscovery Process Management. (IBM is a trademark of International Business Machines Corporation, registered in many jurisdictions worldwide.)

As shown, the memory 106 also contains notice manager 122. In some embodiments, the notice manager 122 is an application configured to generate legal notice documents and workflows surrounding management of their lifecycle by receiving user selection of a predefined content template and a predefined rule template. A content template, in the context of the present disclosure, encapsulates the majority of the language found in a legal notice. A processing rule template, in the context of the present disclosure, provides processing rules used to define workflows surrounding the management of the lifecycle of the legal notice. In some embodiments, the notice manager 122 is a component of eDiscovery application 120, such that the functionality of notice manager 122 is performed by modules of eDiscovery application 120.

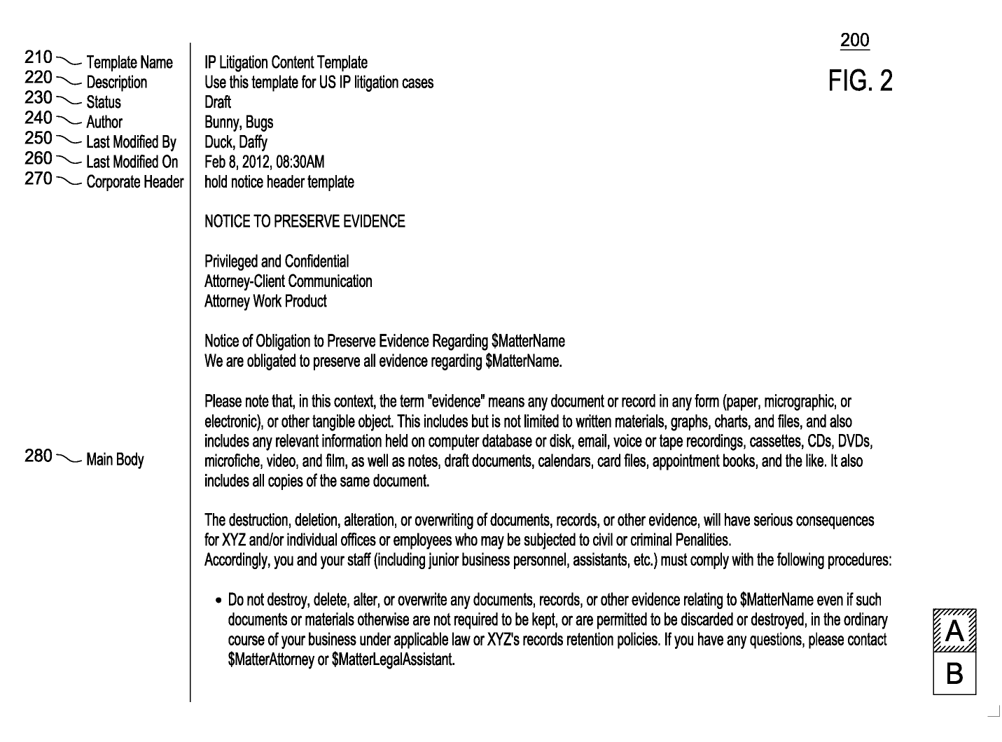

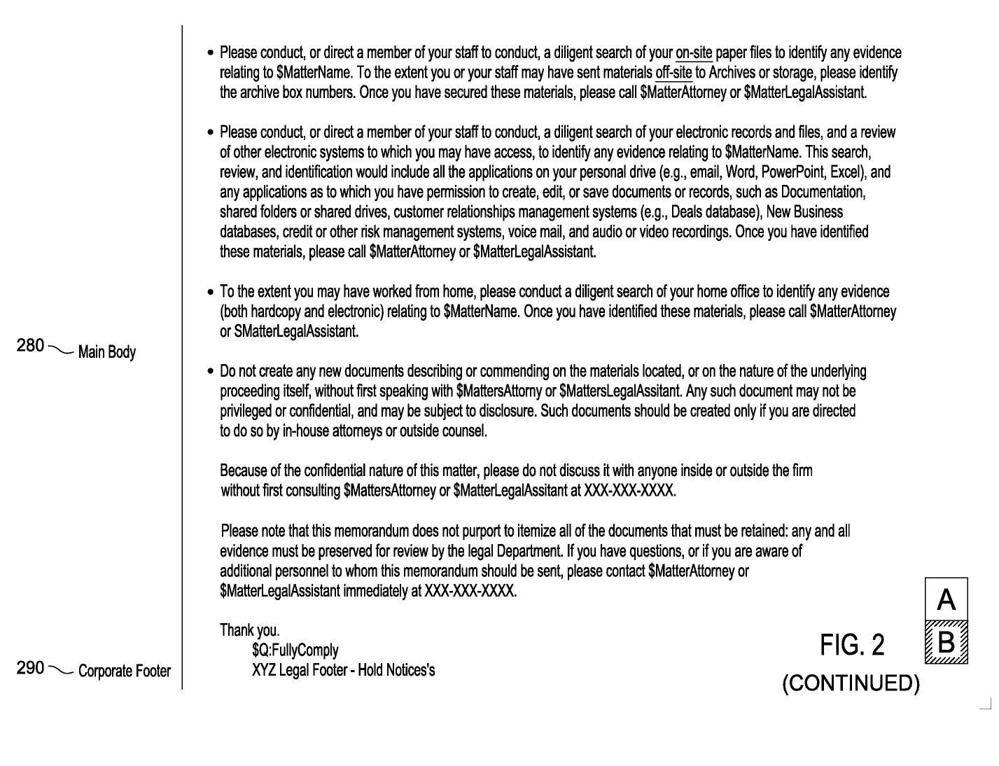

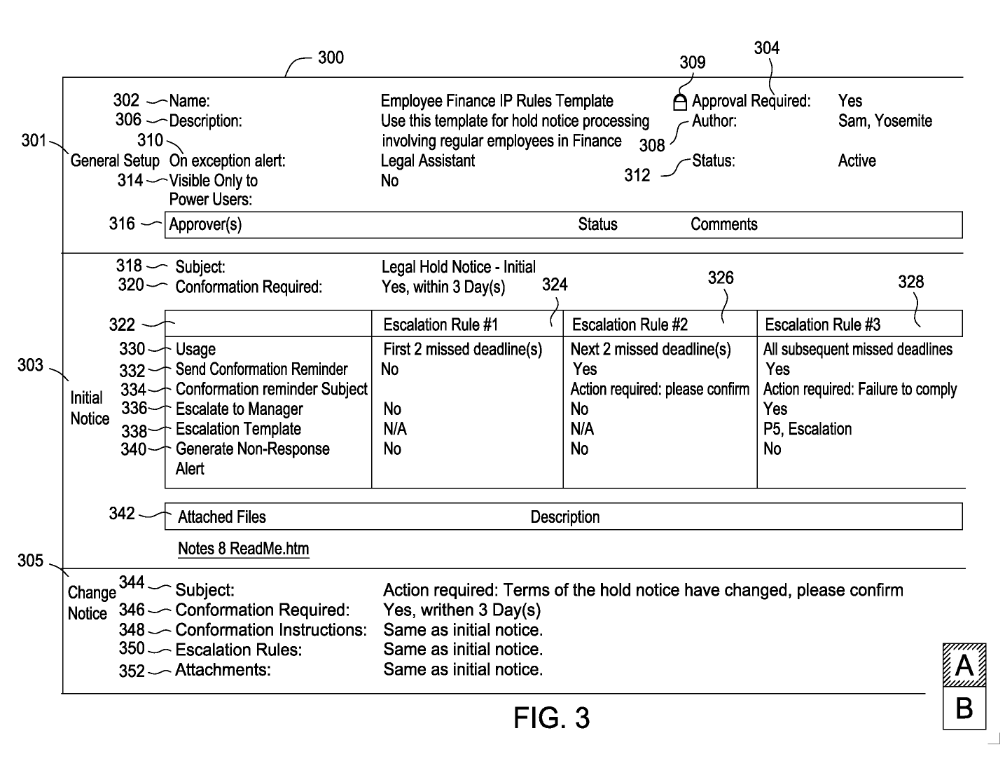

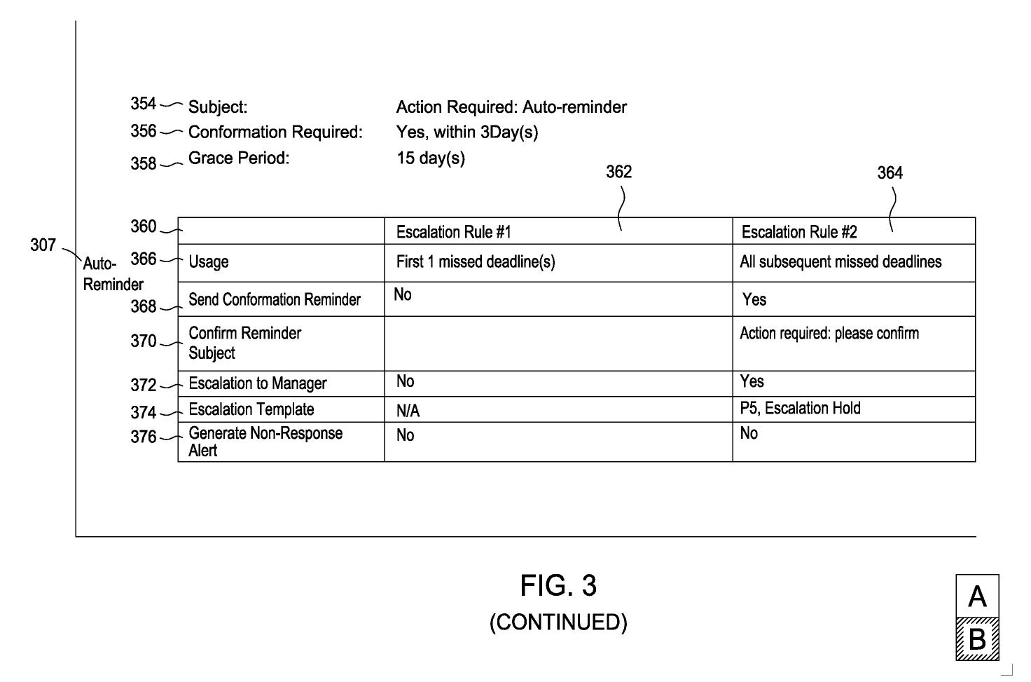

As shown, the storage 108 contains template repository 124. The template repository 124, although depicted as a database in FIG. 1, may take any form sufficient to store data, and the particular storage method chosen should not be considered limiting of the disclosure. In some embodiments described herein, the template repository 124 stores content templates as well as processing rule templates. In other embodiments, separate data structures may be used to store content templates and processing rule templates. As shown, the template repository 124 contains a content template 132 and a processing rule template 134. In some embodiments, the elements of the content template 132 and processing rule template 134 are stored in various locations across the template repository 134. Generally, any method of partitioning and storage of the content template 132 and processing rule template 134 is contemplated, and should not be considered limiting of the disclosure. Exemplary content and processing rule templates are shown in further detail in FIGS. 2 and 3, respectively.

As stated above, the content template 132 encapsulates the majority of the language found in a legal notice. The content template 132 may be specific to a type of legal matter, such as intellectual property, employment, or real property, or may span across multiple types of matters handled by a legal department. Furthermore, the content template 132 may be specific to a stage of the eDiscovery process, such as anticipation of litigation, commencement of litigation, receipt of a discovery request, etc. Alternatively, the content template 132 may also be defined broadly enough to cover all stages of the eDiscovery process. In some embodiments, the information in the content template 132 may include, but is not limited to, a unique name for the content template 132, a description of the content template 132 (i.e., the type of legal matter the content template 132 should be used for), a corporate header to be included in the legal notice, the main contents of the notice (which may contain the legal verbiage related to the legal notice), any attachments to be included to support the legal notice (e.g., documents, images, spreadsheets), and the author of the content template 132. The content template 132, and all content templates generally, are drafted by a user, usually an attorney, and saved to the template repository 124 for future use by others in the organization.

The processing rule template 134 contains configuration elements associated with the lifecycle of the legal notice. Depending on the business process adopted by a legal organization, creators of the processing rule template 134 may choose to lock individual elements of the notice, such that their inclusion is mandatory in all instances of legal notices created using the processing rule template 134. A “locked” configuration element cannot be modified when a legal notice is being created. The processing rule template 134 may be specific to a type of legal notice, such as an initial hold notice, a change notice, or a reminder notice. The configuration elements of the processing rule template 134, and all processing rule templates generally, are defined by a user, usually an attorney, who decides which elements to include in the template, and whether those elements should be locked. The user, upon defining the configuration elements of the processing rule template 134, then saves the processing rule template 134 to the template repository 124. The configuration elements of the processing rule template 134 may include, but are not limited to:

(a) A subject to be used in email communications.

(b) A notice header, which, along with the corporate header in the content template, is specific for a particular type of notice (e.g., initial hold notice, change notice, reminder notice).

(c) Confirmation requirement. The confirmation requirement, if selected, triggers a confirmation workflow in order to receive confirmation of delivery of the notice to a custodian. The confirmation requirement is “lockable.”

(d) Confirmation instructions. Describes the confirmation procedures used to obtain confirmation from the custodian. In some embodiments, this may be an email from the custodian, a link the custodian clicks to confirm delivery, or any number of methods to receive confirmation. Confirmation instructions are “lockable.”

(e) Virtual interview. Specifies that a virtual interview can be used to confirm receipt of a notice by a custodian. Virtual interview selection is “lockable.”

(f) Virtual interview questionnaire. Specifies an approved confirmation virtual interview questionnaire from a library of questionnaires. The virtual interview questionnaire is “lockable.”

(g) Escalation rules. Enables a multi-tiered escalation workflow due to the lack of a response from the custodian. In some embodiments, the escalation workflow is triggered in response to a lack of confirmation. In other embodiments, the escalation workflow is triggered in response to a lack of compliance with the hold notice. In still other embodiments, the escalation workflow is triggered in response to Escalation rules are “lockable.”

(h) Escalation tier. Specifies a tier of escalation based on the number of missed deadlines. A single tier may also be implemented. The principle behind the escalation tiers is that multiple tiers can be provided to address missed deadlines in an increasingly aggressive manner to ensure compliance.

(i) Number of missed deadlines. Specifies the number of missed deadlines for which the escalation rule is applicable. For example, escalation tier 1 can be defined to apply for the first three missed deadlines, and escalation tier 2 may be for all subsequent missed deadlines.

For each escalation tier, the following elements can also be configured:

(i) Send confirmation reminder. Forces the transmission of a confirmation reminder email for the escalation rule.

(ii) Subject of the confirmation reminder email.

(iii) Confirmation reminder header. Free text content along with variables from the confirmation email, including the corporate header, footer, and main body.

(iv) Escalate to manager. Whether to enable a manager escalation workflow upon lack of response to notice.

(v) Escalate to manager subject. The subject of an email sent to the manager of a custodian who has not confirmed receipt of the notice.

(vi) Escalation template. Selected from a pre-defined set of escalation email templates.

(vii) Include initial notice. Indicate whether to include the contents of the initial notice in the confirmation reminder.

(viii) Generate alert. Whether to alert legal staff assigned to the matter of the triggering of an escalation workflow.

By defining different rules for each notice, as well as identifying the roles a custodian plays in an organization, different notice workflows may be defined accordingly. For example, escalation workflows surrounding a legal notice sent to a corporate executive may permit for a greater number of missed deadlines before sending a reminder notice to the executive. Workflows surrounding the same legal notice sent to a lower level employee-custodian may permit for a lesser number of missed deadlines before sending a reminder notice to the custodian.

As shown, the storage 108 also contains eDiscovery data 126. The eDiscovery data 126 is data stored by the eDiscovery application 120, and includes information related to legal matters managed by the eDiscovery application 120. The types of data stored in eDiscovery data 126 include, but are not limited to, documents, legal notices, information related to the legal matter, custodian information, and deadline dates. The eDiscovery data 126, although depicted as a database in FIG. 1, may take any form sufficient to store data, and the particular storage method chosen should not be considered limiting of the disclosure. Although the template repository 124 and the eDiscovery data 126 are shown as being stored in different data structures, they may be stored in the same data structure for access by eDiscovery application 120 and notice manager 122. In some embodiments, the template repository 124 and the eDiscovery data 126 may merged together such that only a single data structure is needed to store both sets of data. For example, the templates stored in the template repository 124 may be stored in the eDiscovery data 126.

FIG. 2 (pages A and B) illustrates an exemplary content template 200, according to one embodiment described herein. As shown on page A of FIG. 2, the exemplary content template 200 contains a template name 210, with a corresponding value of “IP Litigation Content Template.” Page A of the exemplary content template 200 also contains a description 220 with corresponding value “Use this template for US IP litigation cases”, indicating the template should be used for intellectual property litigation cases within the United States. Page A of the exemplary content template 200 also contains a status element 230 with a corresponding value “Draft”, which indicates that the exemplary content template 200 is a draft content template. Page A of the exemplary content template 200 also contains author element 240 and a “last modified by” element 250 with corresponding values of “Bunny, Bugs”, and “Duck, Daffy”, respectively. Page A of the exemplary content template 200 also has “last modified on” element 260 which indicates the date and time the template was last modified, in this example, on “Feb. 8, 2012 at 8:30 A.M.” Page A of the exemplary content template 200 also contains corporate header 270 with a corresponding value of “hold notice header template”. A header (and footer) template combines free form text with pre-defined context specific variables. The exemplary content template 200 also contains main body 280, which in this example has a detailed hold notice letter, and spans both page A and page B of FIG. 2. The main body 280, in addition to static text, also contains variable fields marked by a $ which will be populated as described below when selected by a user to create a hold notice. Finally, page B of the exemplary content template 200 also contains a corporate footer 290 with corresponding value “Legal Footer-Hold Notices”, which indicates that the footer is for hold notices. Although the exemplary content template 200 is shown as having attributes 210-290, the particular attributes shown not be considered limiting of the disclosure.

FIG. 3 (pages A and B) illustrates an exemplary processing rule template 300, according to one embodiment described herein. Although the exemplary processing rule template 300 contains the displayed rules, the particular rules shown should not be considered limiting of the disclosure. As shown, page A of the exemplary processing rule template 300 has four main sections, elements 301, 303, 305, and 307, corresponding to “General Setup”, “Initial Notice”, “Change Notice”, and “Auto-Reminder”, respectively. In General Setup 301, the exemplary processing rule template 300 contains name element 302 with corresponding value “Employee Finance IP Rules Template”, which indicates that the exemplary processing rule template 300 applies to employees of the finance department in intellectual property matters. Element 304 indicates that the processing rule template 300 requires approval. Also note that element 304 is accompanied by a lock 309, which indicates that the approval required element 304 cannot be excluded from any notice generated using this template. Description element 306 and its corresponding value indicates that the processing rule template should be used for hold notice processing involving regular employees in the finance department of the corporation. Author element 308 indicates that the author of the exemplary processing rule template 300 is “Sam, Yosemite.” Element 310, entitled “on exception alert”, indicates that when the eDiscovery application 120 detects an exception related to a notice generated using the exemplary processing rule template 300, a legal assistant will be alerted. Note that element 310 is locked. Status element 312 indicates the status of the template, which in this case is active, but may also have a “draft” status. Element 314 indicates whether the exemplary processing rule template 300 is limited to power users. Element 316 is a table showing a list of individuals who may have approved the exemplary processing rule template 300, along with the status and any comments. In this case, the exemplary processing rule template 300 has yet to be approved, so no approver data is listed.

As stated above, a processing rule template is used to define rules for a plurality of notices, including without limitation, an initial notice, a change notice, and a reminder notice. Element 303 of the exemplary processing rule template 300 contains rules related to the creation of an initial notice. As shown, subject element 318 indicates that the exemplary processing rule template 300 is an initial hold notice. The confirmation required element 320 indicates that a recipient of the notice must provide confirmation of receipt within 3 days of receiving the notice. Table 322 defines a plurality of escalation rules 324, 326, and 328, corresponding to three tiers of escalation rules. Any number of tiers may be implemented. Usage element 330 indicates that escalation rule 324 is to be used after the first two missed deadlines, escalation rule 326 is to be used after the next two deadlines, and escalation rule 238 is to be used after all subsequent deadlines. Send confirmation reminder element 332 indicates that the transmission of an additional reminder requesting confirmation that the notice has been received is not required in escalation rule 324, but is required for escalation rules 326 and 328. Confirmation reminder subject element 334 indicates the subject of an email confirmation reminder to be sent at each tier of escalation rule. Escalate to manager element 336 indicates whether the manager of an intended recipient who has not confirmed receipt of the notice should be notified of the failure to confirm receipt. Escalation template element 338 includes the content of the notice sent to manager of a person who failed to respond. Generate non-response alert element 340 indicates whether an alert should be generated if a response is not received at each escalation tier. Attached files element 342 indicates that a file has been attached to the exemplary processing rule template 300, and will be included with any initial notice generated using the exemplary processing rule template 300.

Element 305 specifies the processing rules related to a change notice generated using the exemplary processing rule template 300. Element 344 specifies the subject of an email sent to a custodian, in this example, “Action required: Terms of the hold notice have changed, please confirm.” Confirmation required element 346 indicates that a recipient must confirm receipt within 3 days of receiving the change notice. Confirmation instructions 348, escalation rules 350, and attachments 352, although they may be specified independently, have each been set to be the same as the initial notice, as described above.

Element 307 specifies the processing rules related to an auto-reminder sent using the exemplary processing rule template 300. The subject element 354 indicates the subject of an email including the auto-reminder. Confirmation required element 356 indicates that a recipient must confirm receipt within 3 days of receiving the auto-reminder. Grace period 358 indicates that a grace period of 15 days will be provided to recipients before further action is taken by the eDiscovery application 120. Table 360 is a set of escalation rules, which in this example contains two tiers, escalation rule 362 and escalation rule 364. Usage element 366 indicates that escalation rule 362 is to be used after the first missed deadline, and that escalation rule 364 is to be used after all subsequent missed deadlines. Send confirmation reminder element 368 indicates that the transmission of an additional reminder requesting confirmation that the notice has been received is not required in escalation rule 362, but is required for escalation rule 364. Confirmation reminder subject element 370 indicates the subject of a confirmation reminder to be sent at each tier of escalation rule. Escalate to manager element 372 indicates whether the manager of an intended recipient who has not confirmed receipt of the notice should be notified of the failure to confirm receipt. Escalation template element 374 includes the content of a notice sent to the manager of the recipient who did not respond. Generate non-response alert element 376 indicates whether an alert should be generated if a response is not received at each escalation tier.

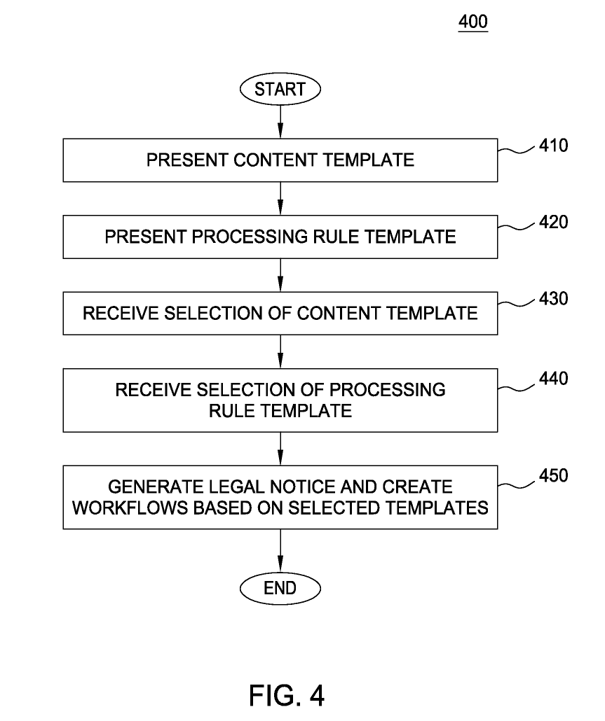

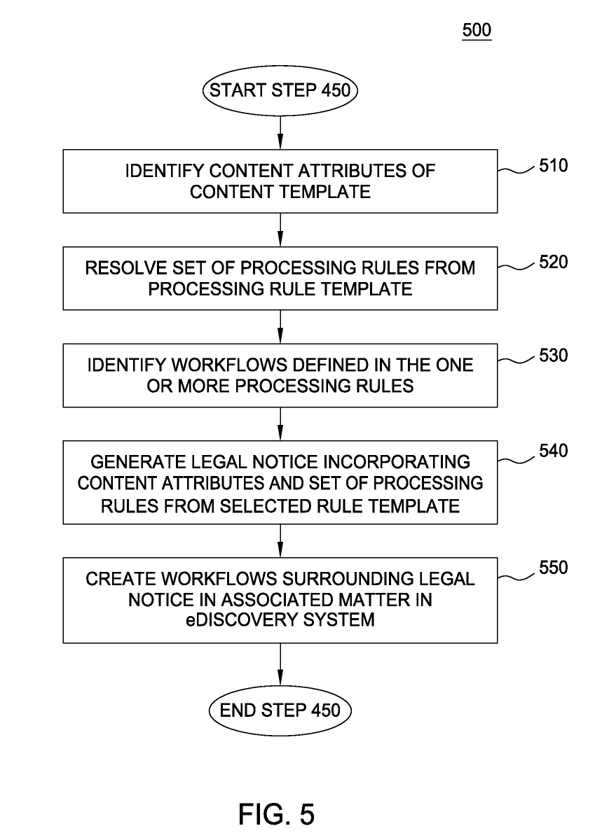

FIG. 4 is a flowchart illustrating a method 400 for generating legal notices and workflows based on predefined templates, according to one embodiment described herein. In some embodiments, the notice manager 122 performs the steps of method 400. At step 410, the notice manager 122 presents a user with a selection of content templates from template repository 124. The displayed content templates correspond to the type of legal matter (e.g., employment, intellectual property, ERISA, etc.) the user is working within, such that only those content templates associated with that type legal matter are displayed for selection. In some embodiments, the legal matter may be predefined and passed as a parameter from within the notice manager 122. In other embodiments, the notice manager retrieves the legal matter from eDiscovery data 126. In still other embodiments, the legal matter may be received as input from the user. The content templates may be presented to the user as a dropdown list, a list associated with radio buttons, or any manner of presentation capable of providing for the selection of a single content template. At step 420, the notice manager 122 presents a user with a selection of processing rule templates from template repository 124. In some embodiments, the user may be presented with the selection of the content templates and the processing rule templates at the same time. In other embodiments, they may be presented in sequence. The displayed processing rule templates may correspond to the target audience (e.g., executives, paralegals, custodians, etc.). The processing rule templates may be presented to the user as a dropdown list, a list associated with radio buttons, or any manner of presentation capable of providing for the selection of a single processing rule template. In some embodiments, the notice manager 122 may present both the content templates and the processing rule templates in the same step. At step 430, the notice manager 122 receives user selection of a content template. At step 440, the notice manager 122 receives user selection of a processing rule template. In some embodiments, the notice manager 122 may receive user selection of the content template and processing rule template in the same submission. In other embodiments, content template and processing rule template may be submitted in separate steps. At step 450, described in greater detail with respect to FIG. 5, the notice manager 122 generates a legal notice and creates surrounding workflows based on the content template and processing rule template selected by the user.

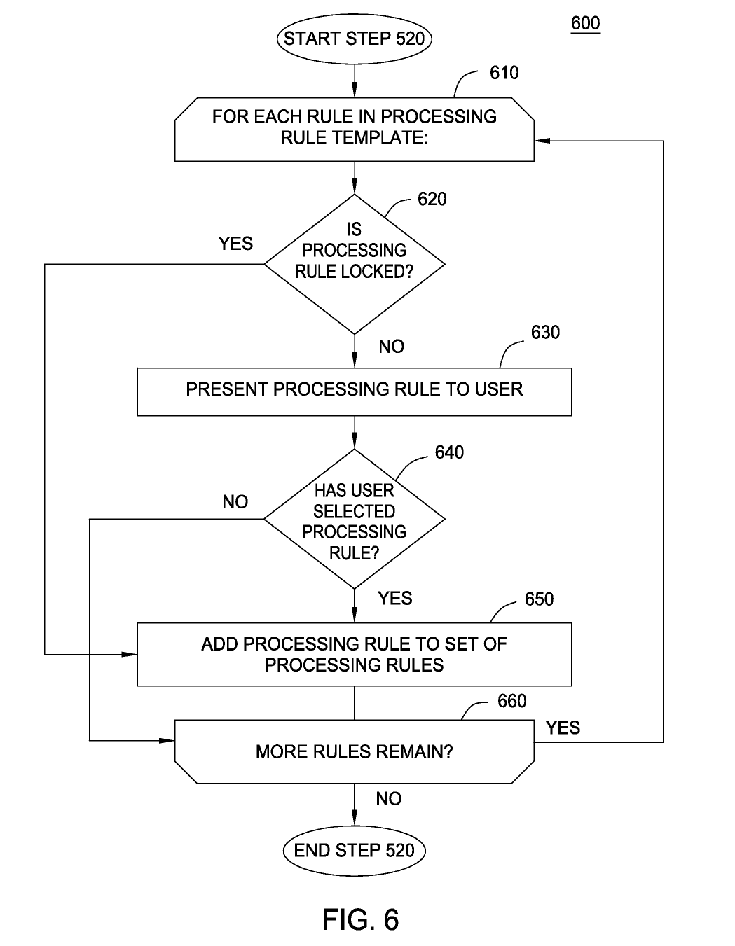

FIG. 5 is a flowchart illustrating a method 500 corresponding to step 450 for generating a legal notice and creating surrounding workflows based on the content template and processing rule template selected by the user. In some embodiments, the notice manager 122 performs the steps of method 500. At step 510, the notice manager 122 identifies the content attributes of the content template selected by the user at step 430. In some embodiments, the notice manager identifies the content attributes by retrieving the content attributes from the selected content template in template repository 124. The notice manager 122, upon retrieving the content attributes, may identify one or more of the content attributes defined above with reference to FIG. 2. At step 520, described in greater detail with reference to FIG. 6, the notice manager 122 resolves a set of processing rules from the selected processing rule template. In some embodiments, the notice manager 122 may resolve the set of processing rules upon receiving selection of the content template at step 440. Generally, the notice manager 122 identifies which rules, if any, have been “locked,” such that their inclusion in the processing rule template is mandatory, and adds them to the set of processing rules. The notice manager 122 then receives user input selecting any optional processing rules, and adds them to the set of processing rules. At step 520, the notice manager 122 may determine which of the set of processing rules are related to the creation of the selected legal notice. In particular, the notice manager 122 must determine which type of notice the user has selected for creation, as the processing rules are different for each type of notice, as shown above with reference to FIG. 3. By identifying those processing rules which are related to the creation of the template, such as the subject or notice header, the notice manager 122 ensures that these rules/attributes will be included in the generated legal notice. At step 530, the notice manager 122 identifies workflows which are defined by the processing rules in the resolved set of processing rules. For example, the processing rule requiring confirmation that the custodian has received the legal notice may have been locked; therefore the notice manager 122 must be create a corresponding workflow in the eDiscovery Application 120 within the legal matter. At step 540, the notice manager 122 generates a legal notice based on the content attributes from the content template and the set of processing rules related to the creation of the legal notice from the selected rule template. By merging the information in the two templates, the notice manager 122 may generate the legal notice. At step 550, the notice manager creates the identified workflows surrounding the legal matter in the eDiscovery application 120. For example, the notice manager 122 may create an entry in eDiscovery application 120 corresponding to the legal matter which requires that a virtual interview be presented to the custodian, as well as a corresponding questionnaire to be completed by the custodian, and a check to determine whether the interview has been completed.

FIG. 6 is a flowchart depicting a method 600 corresponding to step 520 for resolving a set of processing rules to be applied in the lifecycle of the legal notice being created. In some embodiments, the notice manager 122 performs the steps of method 600. At step 610, the notice manager 122 begins executing a loop including steps 620-660 for each processing rule in the processing rule template. At step 620, the notice manager 122 determines whether the processing rule has been locked by the creator of the processing rule template. The notice manager 122 may make this determination by referencing the processing rule template in template repository 124 to determine whether a variable specifying whether the processing rule has been “locked” is set. If the processing rule has been locked, the notice manager 122 proceeds to step 650. Otherwise, the notice manager proceeds to step 630. At step 630, the notice manager 122 presents the processing rule to the user for selection and inclusion in the set of processing rules. In alternate embodiments, all processing rules that are not locked may be presented to the user for selection, and all processing rules that are locked may be added to the set of processing rules at once. In some embodiments, locked processing rules are displayed, but may not be changed or excluded by the user. At step 640, the notice manager 640 determines whether the user has selected the processing rule. If the user has not selected the processing rule, the notice manager proceeds to step 660. If the user has selected the processing rule, the notice manager proceeds to step 650. At step 650, the notice manager 122 adds the processing rule to the set of processing rules. In some embodiments, the notice manager 122 may add the processing rule to the set of processing rules by marking the processing rule with a flag; in other embodiments, the rule may be stored in a temporary data structure indicating which rules have been selected. Generally, the notice manager 122 may use any method suitable for storing or tracking a set of selected processing rules. At step 660, the notice manager determines whether more processing rules remain for processing. If more rules remain, the notice manager returns to step 610. Otherwise, the method 600 ends.

The flowchart and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Using content templates and processing rule templates, legal organizations are able to establish repeatable, defensible, and consistent processes around legal notices. Authorized users within the legal organization author and manage a repository of the content templates used for a variety of legal matters, such as intellectual property, employment law, mortgages, etc. Since rules can vary depending on the role, organization, and geographical location of the custodian, processing rule templates can also be established targeting various categories of custodians. For example, separate rules could be established for custodians who are corporate executives as compared to rules established for non-executives in the corporation. By using content templates and processing rule templates, legal organizations are able to establish a process whereby a large number of users with limited legal training and skills can create legal notices that is simple, efficient, reliable, and compliant with polices, regulations, rules, and laws.

While the foregoing is directed to embodiments of the present disclosure, other and further embodiments of the disclosure may be devised without departing from the basic scope thereof, and the scope thereof is determined by the claims that follow.

What is claimed is:

1. A computer-implemented method for creating legal notices in a matter in an electronic discovery management system, comprising:
providing a plurality of content templates for a legal notice, the content templates each comprising at least one attribute of the legal notice, wherein each content template is specific to a type of matter in the electronic discovery management system;
providing a plurality of processing rule templates, each processing rule template comprising at least one processing rule, wherein the at least one processing rule defines rules and workflows related to at least one of the: (i) creation, (ii) transmission, and (iii) monitoring of the legal notice; wherein combinations of the processing rule templates and the content templates is used to generate legal notices; and
responsive to receiving selection of a first content template and a first processing rule template, generating, by operation of one or more computer processors, a legal notice and workflows based on the first content template and the first processing rule template.

2. The computer-implemented method of claim 1, wherein generating the legal notice comprises:
identifying a set of content attributes defined in the first content template;
resolving a set of one or more processing rules defined in the first processing rule template;
identifying a set of workflows defined in the one or more processing rules;
generating the legal notice incorporating the set of content attributes and the one or more processing rules related to creation of the legal notice; and
creating the identified workflows within the matter in the electronic discovery management system.

3. The computer-implemented method of claim 2, wherein resolving a set of one or more processing rules comprises:
upon determining that the inclusion of a first one of the processing rules in the processing rule template is mandatory, including the first processing rule in the set of one or more processing rules; and
upon determining that the inclusion of a second one of the processing rules in the processing rule template is optional:
presenting the second processing rule to a user; and
upon receiving user input selecting the second processing rule, including the second processing rule in the set of one or more processing rules.

4. The computer-implemented method of claim 3, wherein the workflows comprise at least a set of escalation rules related to monitoring the legal notice.

5. The computer-implemented method of claim 1, wherein the at least one attribute is based on at least one of: (i) the role, (ii) the organization, and (iii) the geographic location of a custodian involved in the matter.

6. The computer-implemented method of claim 1, wherein the generated legal notice is approved for transmission.

7. The computer-implemented method of claim 1, wherein the at least one attribute cannot be modified, wherein the at least one attribute must be included in the legal notice.

8. The computer-implemented method of claim 1, wherein the legal notice is at least one of an initial hold notice, a change notice, and a reminder notice.

9. A computer program product for creating legal notices, the computer program product comprising:
a computer-readable storage medium having computer-readable program code embodied therewith, the computer-readable program code comprising:
computer-readable program code configured to provide a plurality of content templates for a legal notice, the content templates comprising at least one attribute of the legal notice, wherein each content template is specific to a type of matter in the eDiscovery management system;
computer-readable program code configured to provide a plurality of processing rule templates comprising at least one processing rule, wherein the at least one processing rule defines rules and workflows related to at least one of the: (i) creation, (ii) transmission, and (iii) monitoring of the legal notice; and
computer-readable program code configured to, responsive to receiving selection of a first content template and a first processing rule template, generate a legal notice and workflows based on the content template and the processing rule template.

10. The computer program product of claim 9, wherein generating the legal notice comprises:
computer-readable program code configured to identify a set of content attributes defined in the first content template;
computer-readable program code configured to resolve a set of one or more processing rules defined in the first processing rule template;
computer-readable program code configured to identify a set of workflows defined in the one or more processing rules;
computer-readable program code configured to generate the legal notice incorporating the set of content attributes and the one or more processing rules related to creation of the legal notice; and
computer-readable program code configured to create the identified workflows within the matter in the eDiscovery management system.

11. The computer program product of claim 10, wherein resolving a set of one or more processing rules comprises:
upon determining that the inclusion of a first one of the processing rules in the processing rule template is mandatory, including the first processing rule in the set of one or more processing rules; and
upon determining that the inclusion of a second one of the processing rules in the processing rule template is optional:
presenting the second processing rule to a user; and
upon receiving user input selecting the second processing rule, including the second processing rule in the set of one or more processing rules.

12. The computer program product of claim 11, wherein the workflows comprise at least a set of escalation rules related to monitoring the legal notice.

13. The computer program product of claim 9, wherein the at least one attribute is based on at least one of: (i) the role, (ii) the organization, and (iii) the geographic location of a custodian involved in the matter.

14. The computer program product of claim 9, wherein the generated legal notice is approved for transmission.

15. The computer program product of claim 9, wherein the at least one attribute cannot be modified, wherein the at least one attribute must be included in the legal notice.

16. The computer program product of claim 9, wherein the legal notice is at least one of an initial hold notice, a change notice, and a reminder notice.

17. A system, comprising:
one or more computer processors; and
a memory containing a program, which when executed by the one or more computer processors is configured to perform an operation for creating legal notices, the operation comprising:
providing a plurality of content templates for a legal notice, the content templates comprising at least one attribute of the legal notice, wherein each content template is specific to a type of matter in the eDiscovery management system;
providing a plurality of processing rule templates comprising at least one processing rule, wherein the at least one processing rule defines rules and workflows related to at least one of the: (i) creation, (ii) transmission, and (iii) monitoring of the legal notice; and
responsive to receiving selection of a first content template and a first processing rule template, generating, by operation of one or more computer processors, a legal notice and workflows based on the content template and the processing rule template.

18. The system of claim 17, wherein generating the legal notice comprises:
identifying a set of content attributes defined in the first content template;
resolving a set of one or more processing rules defined in the first processing rule template;
identifying a set of workflows defined in the one or more processing rules;
generating the legal notice incorporating the set of content attributes and the one or more processing rules related to creation of the legal notice; and
creating the identified workflows within the matter in the eDiscovery management system.

19. The system of claim 18, wherein resolving a set of one or more processing rules comprises:
upon determining that the inclusion of a first one of the processing rules in the processing rule template is mandatory, including the first processing rule in the set of one or more processing rules; and
upon determining that the inclusion of a second one of the processing rules in the processing rule template is optional:
presenting the second processing rule to a user; and
upon receiving user input selecting the second processing rule, including the second processing rule in the set of one or more processing rules.

20. The system of claim 19, wherein the workflows comprise at least a set of escalation rules related to monitoring the legal notice.

21. The system of claim 17, wherein the at least one attribute is based on at least one of: (i) the role, (ii) the organization, and (iii) the geographic location of a custodian involved in the matter.

22. The system of claim 17, wherein the generated legal notice is approved for transmission.

23. The system of claim 17, wherein the at least one attribute cannot be modified, wherein the at least one attribute must be included in the legal notice.

24. The system of claim 17, wherein the legal notice is at least one of an initial hold notice, a change notice, and a reminder notice.
